(19) United States
(12) Patent Application Publication
(10) Pub. No.: US 2008/0075820 A1
(43) Pub. Date: Mar. 27, 2008

(54) System and method for adding moisture to food during barbecue grilling

(76) Inventor: Raymon E. Fernandez, Las Vegas, NV (US)

Correspondence Address: WEISS & MOY PC, 4204 NORTH BROWN AVENUE, SCOTTSDALE, AZ, 85251, US

(21) Appl. No.: 11/525,630

(22) Filed: Sep. 25, 2006

(51) Int. Cl. A23B 4/06

(52) U.S. Cl. 426/506

(57) ABSTRACT

A system and method for adding moisture to food during barbecue grilling is disclosed. The method comprises the steps of providing food, providing ice cubes, placing the food on a barbecue grill, positioning the ice cubes on the barbecue grill adjacent to the food, and providing sufficient heat to melt the ice cubes and to cook the food. As the ice cubes melt, water from the ice cubes drips onto the heat source, causing water vapor to rise, thereby providing moisture to the food. In some embodiments, the ice cubes are provided with wood particles, such as mesquite, cherry, hickory, oak, etc., in order to provide flavoring for the food in addition to moisture. The system for adding moisture to food during barbecue grilling comprises an ice cube tray, a container containing a plurality of wood particles, and a package holding the ice cube tray and container.

### FIELD OF THE INVENTION

This invention relates generally to barbecue grilling and, more particularly, to a system and method for adding moisture to food during barbecue grilling.

### BACKGROUND OF THE INVENTION

Barbecue grilling is a well-known and increasingly popular method of food preparation. According to the Hearth, Patio & Barbecue Association, the barbecuing industry experienced an overall 44 percent increase from 1992 to 2005. In the United States, barbecue grilling is especially popular during the summer months, and particularly on national holidays, such as Memorial Day, Independence Day, and Labor Day. It is estimated that 81 percent of United States households own barbecue grills, with 22 percent of such households owning more than one grill.

A problem exists with barbecue grilling in general, in that the process often dries out the food being grilled. This is especially true with meats, game, and fish, etc., which may lose a substantial amount of natural moisture during barbecue grilling. Some chefs recommend brushing the food with oils, sauces, or the like during barbecue grilling, to prevent the food from drying out. While this may be an effective method, it may not be desirable for particular individuals, such as those with diet restrictions or those who do not care for the application of oil, sauces, or the like to their food.

A need therefore exists for a method for adding moisture to food during barbecue grilling that does not require the use of oils, sauces, or the like.

The present invention satisfies these needs and provides other, related advantages.

### SUMMARY OF THE INVENTION

In accordance with an embodiment of the present invention, a method for adding moisture to food during barbecue grilling is disclosed. The method comprises the steps of: providing food; providing ice cubes; placing the food on a barbecue grill; positioning the ice cubes on the barbecue grill adjacent to the food; and providing sufficient heat to melt the ice cubes and to cook the food.

In accordance with another embodiment of the present invention, a method for adding moisture and flavor to food during barbecue grilling is disclosed. The method comprises the steps of: providing food; providing ice cubes, wherein the ice cubes contain wood particles comprising one of mesquite, cherry, hickory and oak; placing the food on a barbecue grill; positioning the ice cubes on the barbecue grill adjacent to the food; and providing sufficient heat to melt the ice cubes and to cook the food.

In accordance with a further embodiment of the present invention, a system for adding moisture and flavor to food during barbecue grilling is disclosed. The system comprises, in combination: an ice cube tray; a container containing a plurality of wood particles; and a package holding the ice cube tray and container.

### BRIEF DESCRIPTION OF THE DRAWINGS

FIG. 1 is a perspective view of an ice cube tray device, which may be utilized in connection with an embodiment of the present invention.

FIG. 2 is perspective view of an ice cube tray container device for the ice cube tray device of FIG. 1.

FIG. 3 is a perspective, exploded view of the ice cube tray device of FIG. 1, containing water and wood particles therein, and the ice cube tray container device of FIG. 2.

FIG. 4 is a perspective, unexploded view of the embodiment of FIG. 3.

FIG. 5 is a cross-sectional view of the ice cube tray device of FIG. 1, containing wood particles therein.

FIG. 6 is a cross-sectional view of the ice cube tray device of FIG. 1, containing water and wood particles therein.

FIG. 7 is a perspective view of a packaged ice cube tray device, an ice cube tray container device, and a wood particle packet, consistent with an embodiment of the present invention.

FIG. 8 is a perspective view of a packaged ice cube tray device, an ice cube tray container device, and wood particle packets, consistent with an embodiment of the present invention.

FIG. 9 is a perspective view of ice cubes containing wood particles therein, consistent with an embodiment of the present invention.

FIG. 10 is a perspective view of a barbecue grill with food and the ice cubes of FIG. 9 positioned on a rack thereof.

FIG. 11 is a flowchart showing the steps involved in an embodiment of the present invention.

FIG. 12 is a flowchart showing the steps involved in an embodiment of the present invention.

### DETAILED DESCRIPTION OF THE PREFERRED EMBODIMENTS

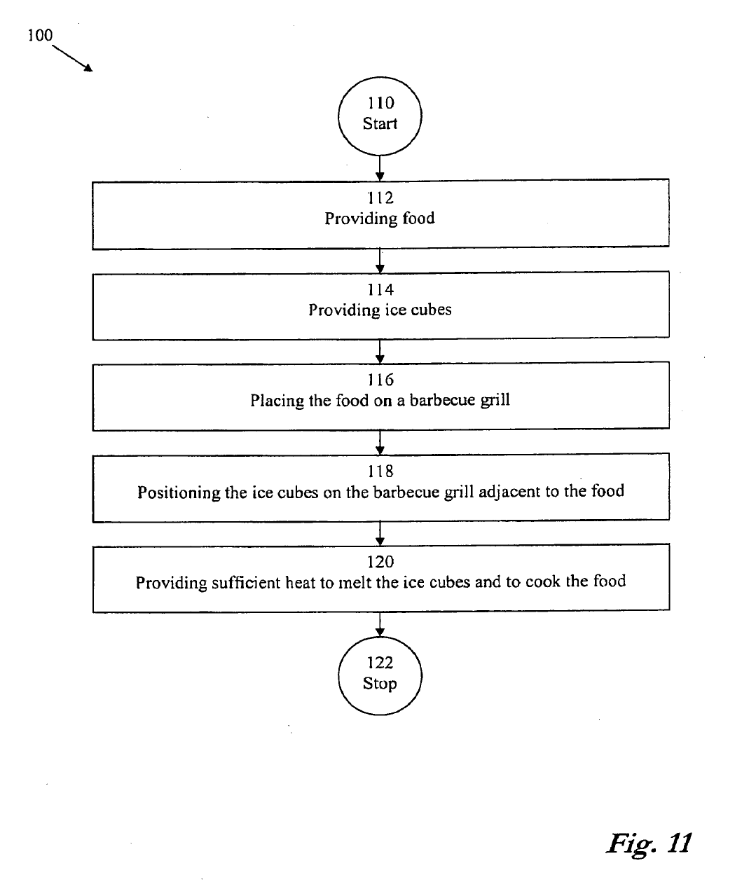

Referring first to FIG. 11, a flowchart shows the steps of a method for adding moisture to food during barbecue grilling (hereinafter the “method 100”), consistent with an embodiment of the present invention. The method 100 is useful for preventing food from drying out during barbecue grilling, without the need for adding oils, sauces, or the like to the food. In one embodiment, the method 100 comprises several steps. The first step consists of providing food 112. The food may consist of any type of food that a user wishes to grill using the method of the present invention. In one embodiment, the food consists of meat 32, as seen in FIG. 10. In another embodiment, the food consists of game, fish, etc. (not shown).

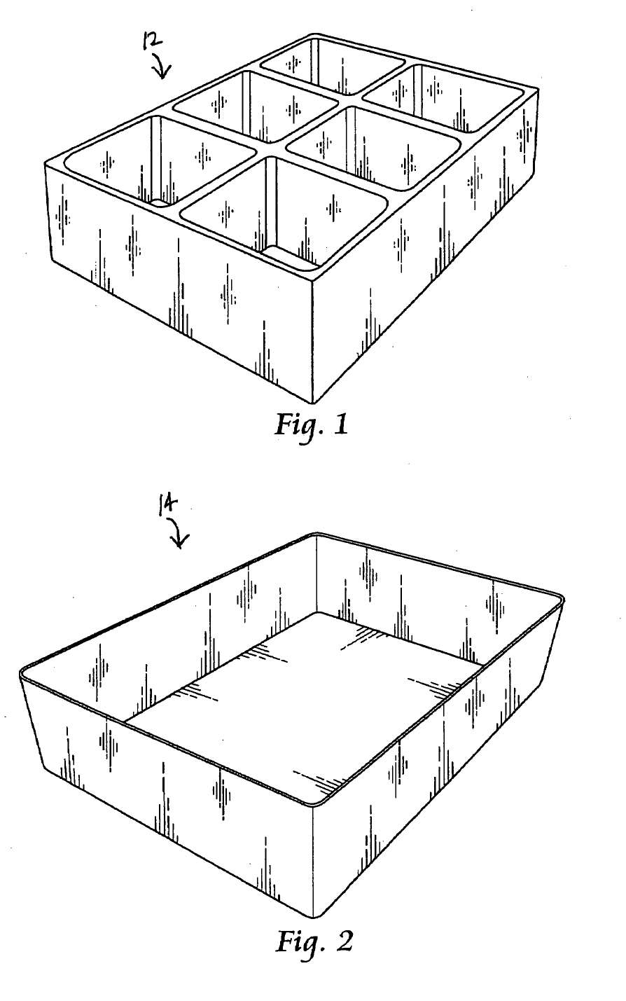

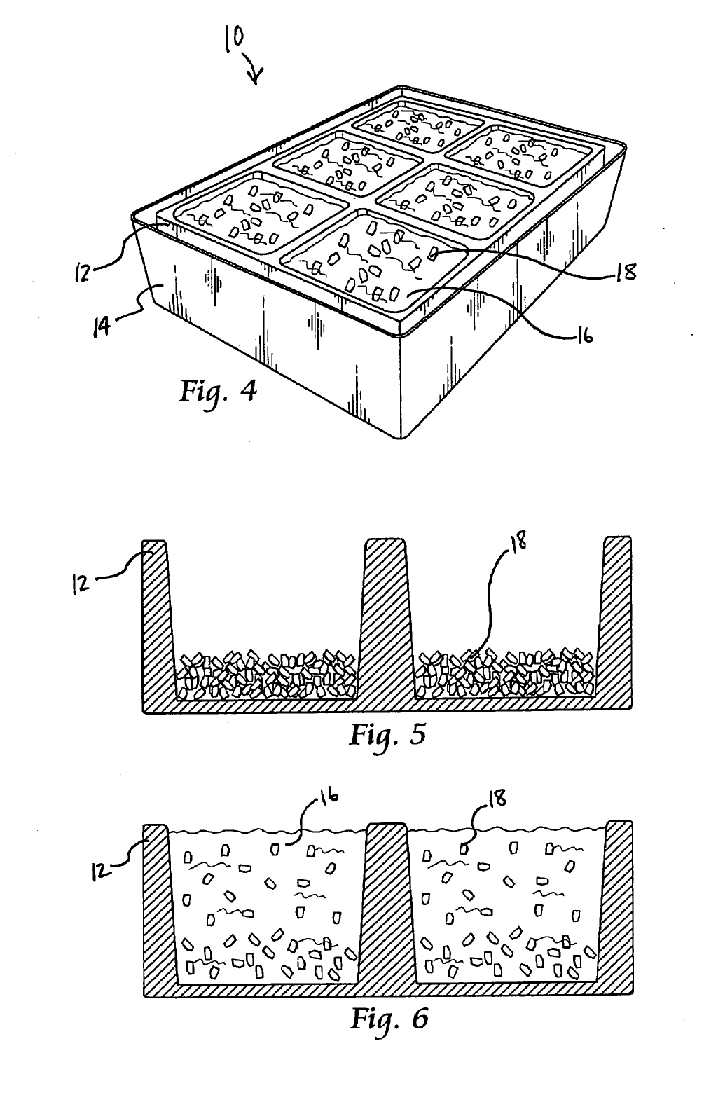

The next step consists of providing ice cubes 114. Preferably, the ice cubes are larger than standard ice cubes. However, it would be possible for the ice cubes to be of a standard size, such as those prepared with standard household ice cube trays. In one embodiment, as shown collectively in FIGS. 1 and 2, a specialized ice cube tray 12 and ice cube tray container 14 are used for preparation of ice cubes. In the embodiment shown in FIG. 17 the ice cube tray 12 has dimensions of 6 inches by seven inches by 2 inches. However, the ice cube tray 12 may have any number of other conceivable dimensions, as desired. The ice cube tray container 14 preferably has dimensions slightly greater than the dimensions of the ice cube tray 12, such that the ice cube tray 12 may rest within the ice cube tray container 14 (as seen in FIG. 4).

The next step consists of placing the food on a barbecue grill 116. In one embodiment, as seen in FIG. 10, the barbecue grill, which may be a standard gas barbecue grill 30, is employed. In another embodiment, any standard barbecue grill may be used, such as a charcoal grill (not shown). The gas barbecue grill 30 preferably includes a lower portion for containing a heat source, along with a rack positioned above the heat source. The food may consist of meat 32, as discussed above and as shown in FIG. 10. As further shown in FIG. 10, the meat 32 (or some other type of food) should be positioned on the rack, above the heat source.

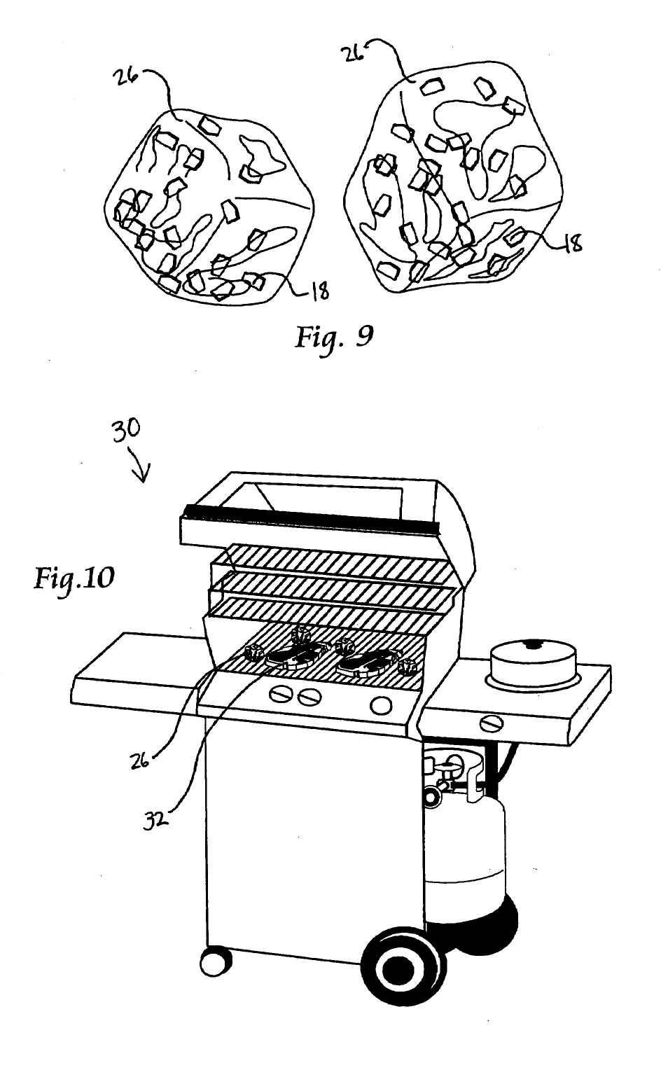

The next step consists of positioning the ice cubes on the barbecue grill adjacent to the food 118. Examples of ice cubes 26 are shown in FIGS. 9 and 10. As best seen in FIG. 10, the ice cubes 26 should be positioned on the rack, above the heat source. In this way, when the ice cubes 26 begin to melt during the next step discussed below, water from the ice cubes 26 will fall onto the beat source, and become water vapor. The water vapor will travel upwardly in the direction of the food, thereby providing moisture to the food.

The final step of the method 100 consists of providing sufficient heat to melt the ice cubes and to cook the food 120. In one embodiment, the heat source consists of a plurality of coals suitable for barbecue grilling, such as standard charcoal. In another embodiment, it may be desired to employ ceramic briquettes, lava rocks, or the like in the event that a gas barbecue grill 30, as opposed to a charcoal grill, is used. After the ice cubes 26 melt, it may be desired to repeat the step of positioning the ice cubes on the barbecue grill adjacent to the food 118, above the heat source, until the food has been thoroughly cooked.

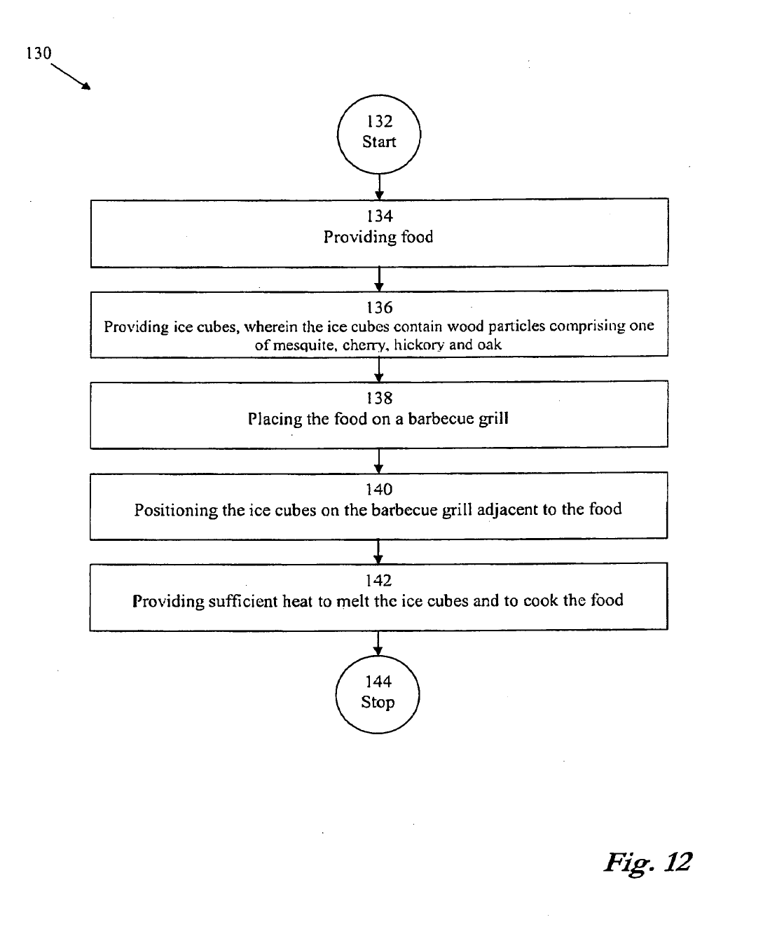

Referring next to FIG. 12, a flowchart shows the steps of a method for adding moisture to food during barbecue grilling (hereinafter the “method 130”), consistent with an embodiment of the present invention. As with the method 100, the method 130 is useful for preventing food from drying out during barbecue grilling, without the need for adding oils, sauces, or the like to the food. In addition, the method 130 is useful for adding flavor to the food being grilled. In this embodiment, the method 130 comprises several steps. The first step consists of providing food 134. As with the method 100, the food may consist of any type of food that a user wishes to grill using the method of the present invention. In one embodiment, the food consists of meat 32, as seen in FIG. 10. In another embodiment, the food consists of game, fish, etc. (not shown).

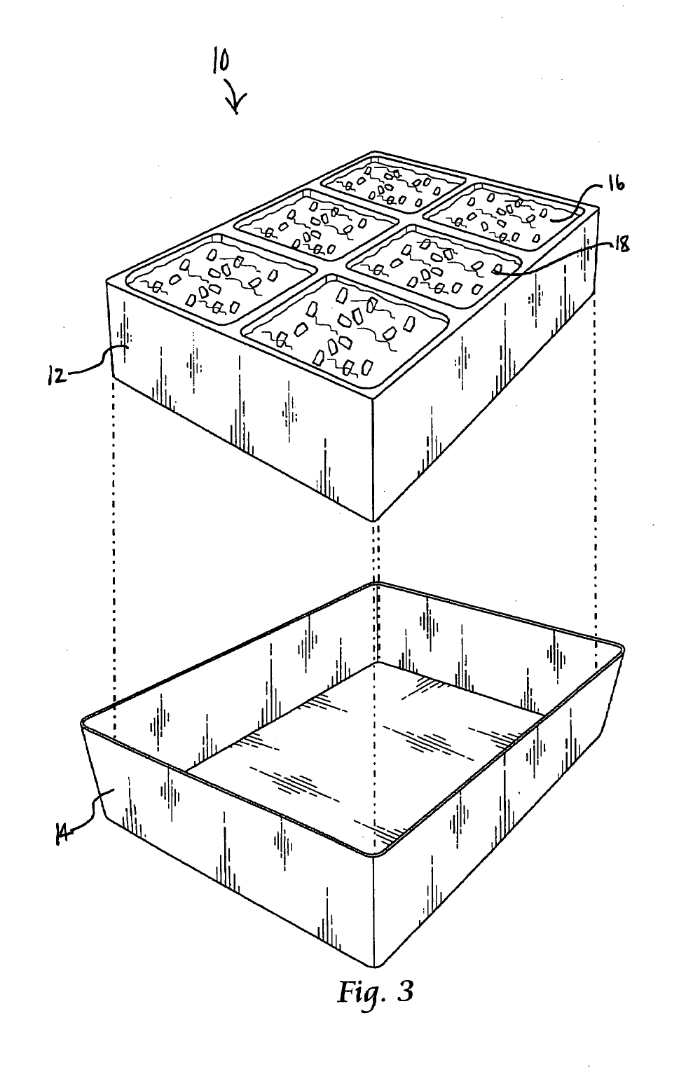

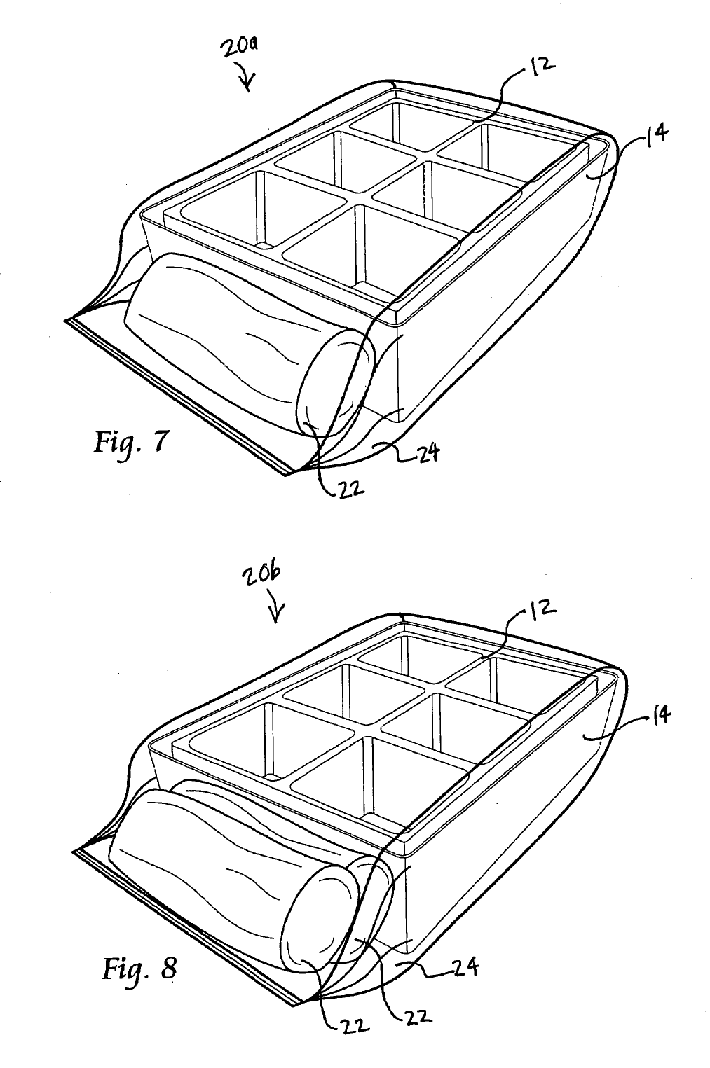

The next step consists of providing ice cubes, wherein the ice cubes contain wood particles comprising one of mesquite, cherry, hickory and oak 136. In a preferred embodiment, as shown in FIGS. 3, 4, 5, 6 and 9, wood particles 18, in a form resembling sawdust, are used. However, it may be desired for the wood particles 18 to be somewhat larger or smaller than typical sawdust particles. FIGS. 9 and 10 demonstrate a preferred embodiment of ice cubes 26 containing the wood particles 18. To prepare the ice cubes 26, preferably the wood particles 18 are placed in an ice cube tray 12, as seen in FIG. 5, to which water 16 is then added, as demonstrated in FIG. 6. The ice cube tray 12 containing the wood particles 18 and water 16 may then be placed in a freezer until ice has formed. As with the method 100, preferably, the ice cubes are larger than standard ice cubes. However, it would be possible for the ice cubes to be of a standard size, such as those prepared with standard household ice cube trays. As discussed above, in one embodiment, as shown collectively in FIGS. 2 and 2, a specialized ice cube tray 12 and ice cube tray container 14 are used for preparation of ice cubes. In the embodiment shown in FIG. 1, the ice cube tray 12 has dimensions of 6 inches by seven inches by 2 inches. However, the ice cube tray 12 may have any number of other conceivable dimensions, as desired. The ice cube tray container 14 preferably has dimensions slightly greater than the dimensions of the ice cube tray 12, such that the ice cube tray 12 may rest within the ice cube tray container 14 (as seen in FIG. 4). With respect to the wood particles 18, in a preferred embodiment, they consist of mesquite, cherry, hickory or oak. However, it may be desired to use some other type of wood particles 26 suitable for grilling. Some other types of wood particles 26 used for grilling also include alder, apple, grapevine, maple, pear, and pecan, and the like.

The next step consists of placing the food on a barbecue grill 138. As discussed above, in one embodiment, as seen in FIG. 10, the barbecue grill, which may be a standard gas barbecue grill 30, is employed. In another embodiment, any standard barbecue grill may be used, such as a charcoal grill (not shown). The gas barbecue grill 30 preferably includes a lower portion for containing a heat source, along with a rack positioned above the heat source. The food may consist of meat 32, as discussed above and as shown in FIG. 10. As further shown in FIG. 10, the meat 32 (or some other type of food) should be positioned on the rack, above the heat source.

The next step consists of positioning the ice cubes on the barbecue grill adjacent to the food 140. Again, examples of ice cubes 26 are shown in FIGS. 9 and 10. As best seen in FIG. 10, the ice cubes 26 should be positioned on the rack, above the heat source. In this way, when the ice cubes 26 begin to melt during the next step discussed below, water from the ice cubes 26 will fall onto the heat source, and become water vapor. The water vapor will travel upwardly in the direction of the food, thereby providing moisture to the food. In addition, as the ice cubes 26 melt, the wood particles 18 contained therein will drop onto the surface of the heat source and begin to smoke. The smoke will travel upwardly along with the water vapor and impart flavor onto the food.

The final step of the method 130 consists of providing sufficient heat to melt the ice cubes and to cook the food 142. In one embodiment, the heat source consists of a plurality of coals suitable for barbecue grilling, such as standard charcoal. In another embodiment, it may be desired to employ ceramic briquettes, lava rocks, or the like in the event that a gas barbecue grill 30, as opposed to a charcoal grill, is used. After the ice cubes 26 melt, it may be desired to repeat the step of positioning the ice cubes on the barbecue grill adjacent to the food 140, above the heat source, until the food has been thoroughly cooked.

Turning now to FIG. 7, in a preferred embodiment, the ice cube tray 12, ice cube tray container 14 and a packet 22 containing wood particles 18 (not shown) may be packaged together in a resealable bag 24 or other packaging, comprising one unit 20a. In another embodiment, as shown in FIG. 8, another unit 20b may consist of the ice cube tray 12, ice cube tray container 14 and at least two packets 22 containing wood particles 18 (not shown) packaged together in a resealable bag 24 or other packaging.

While the invention has been particularly shown and described with reference to the preferred embodiments thereof, it will be understood by those skilled in the art that the foregoing and other changes in form and details may be made therein without departing from the spirit and scope of the invention.

I claim:

1. A method for adding moisture to food during barbecue grilling comprising the steps of:
providing food;
providing ice cubes;
placing the food on a barbecue grill;
positioning the ice cubes on the barbecue grill adjacent to the food; and
providing sufficient heat to melt the ice cubes and to cook the food.

2. The method of claim 1 wherein the ice cubes contain therein a plurality of wood particles.

3. The method of claim 2 wherein the wood particles are in a sawdust-like form.

4. The method of claim 2 wherein the wood particles are comprised of mesquite.

5. The method of claim 2 wherein the wood particles are comprised of cherry.

6. The method of claim 2 wherein the wood particles are comprised of hickory.

7. The method of claim 2 wherein the wood particles are comprised of oak.

8. The method of claim 1 wherein the food consists of one or more of meat, game, and fish.

9. A method for adding moisture and flavor to food during barbecue grilling comprising the steps of:
providing food;
providing ice cubes, wherein the ice cubes contain wood particles comprising one of mesquite, cherry, hickory and oak;
placing the food on a barbecue grill;
positioning the ice cubes on the barbecue grill adjacent to the food; and
providing sufficient heat to melt the ice cubes and to cook the food.

11. The method of claim 9 wherein the wood particles are in a sawdust-like form.

12. A system for adding moisture and flavor to food during barbecue grilling comprising, in combination:
an ice cube tray;
a container containing a plurality of wood particles; and
a package holding the ice cube tray and container.

13. The system of claim 12 further comprising a tray dimensioned to receive the ice cube container.

14. The system of claim 12 further comprising a plurality of containers containing a plurality of wood particles.
